(19) United States
(12) Patent Application Publication
(10) Pub. No.: US 2010/0142136 A1
(43) Pub. Date: Jun. 10, 2010

(54) METHOD AND APPARATUS THAT ISOLATES A COMPUTER SYSTEM FROM VIBRATIONS GENERATED BY INTERNAL FANS

(75) Inventors: Anton A. Bougaev, La Jolla, CA (US); Aleksey M. Urmanov, San Diego, CA (US); Kenny C. Gross, San Diego, CA (US); David K. McElfresh, San Diego, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/330,343

(22) Filed: Dec. 8, 2008

(51) Int. Cl. G06F 1/16

(52) U.S. Cl. 361/679.02

(57) ABSTRACT

Some embodiments of the present invention provide an apparatus that isolates a computer system from vibrations generated by one or more fans inside the computer system. The apparatus includes a fan deck upon which the one or more fans are mounted inside the computer system, and three spring assemblies. Each spring assembly includes: a pin that extends through a clearance hole in the fan deck, wherein a first end of the pin is rigidly coupled to the computer system; a lower spring that extends between a first side of the fan deck and a lower spring mount coupled to the pin; and an upper spring that extends between a second side of the fan deck and a upper spring mount coupled to the pin.

### BACKGROUND

1. Field

The present invention generally relates to techniques for isolating vibrations in computer systems. More specifically, the present invention relates to a method and an apparatus that isolates a computer system from vibrations generated by one or more fans inside the computer system.

2. Related Art

Many new computer systems include powerful processors that require powerful fans to cool them. These powerful fans can increase the vibrations generated in the computer system, which can lead to performance problems for components in the computer system. For example, many new higher density disk drives have smaller track sizes and tighter tolerances to increase their storage capacity. However, smaller track sizes and tighter tolerances make these disk drives potentially more sensitive to vibrations during operation of the computer system.

Often, computer system manufacturers try to isolate vibrations generated by fans from the rest of the computer system using elastomeric mounts for the fan. Typically, each fan in the computer system is separately mounted and isolated. However, the elastomeric mounts can undergo stress relaxation over their life cycle due to temperature cycling and flexing which may reduce the ability of the elastomeric mounts to damp vibrations. The loss of damping ability may occur before the computer system has reached the end of its estimated useful life cycle, and may allow vibrations from the fan to be transmitted to the rest of the computer system, including the disk drives. Moreover, since each fan is typically separately isolated, the deterioration of one of the elastomeric mounts on any one of the fans can lead to a failure of isolation and result in vibrations being transmitted to the computer system. This can lead to performance degradation or even failure of the computer system, or can require a reduction in fan speed to reduce the vibrations generated by a fan, thereby limiting the maximum amount of heat that can be safely generated by a processor cooled by the fan, and hence limiting the maximum speed of the processor.

Hence, what is needed is a method and system that isolates a computer system from vibrations generated by one or more fans inside the computer system without the above-described problems.

### SUMMARY

Some embodiments of the present invention provide an apparatus that isolates a computer system from vibrations generated by one or more fans inside the computer system. The apparatus includes a fan deck upon which the one or more fans are mounted inside the computer system, and three spring assemblies. Each spring assembly includes: a pin that extends through a clearance hole in the fan deck, wherein a first end of the pin is rigidly coupled to the computer system; a lower spring that extends between a first side of the fan deck and a lower spring mount coupled to the pin; and an upper spring that extends between a second side of the fan deck and a upper spring mount coupled to the pin.

In some embodiments, the lower spring mount in each spring assembly is located between the computer system and the first side of the fan deck, and the upper spring mount in each spring assembly is located between the second end of the pin and the second side of the fan deck.

In some embodiments, the lower spring in each spring assembly is preloaded between the first side of the fan deck and the lower spring mount, and the upper spring is preloaded between the second side of the fan deck and the upper spring mount.

In some embodiments, at least one of the lower spring in each spring assembly and the upper spring in each spring assembly includes a cylindrical helical coil spring.

In some embodiments, at least one of the lower spring in each spring assembly and the upper spring in each spring assembly includes a metal spring.

In some embodiments, a spring constant of the lower spring in each spring assembly, a spring constant of the upper spring in each spring assembly, and a mass of the fan deck and the one or more fans are selected so that a ratio of a fundamental vibration frequency generated by the one or more of the fans during operation of the computer system to a resonant vibration frequency of the fan deck is greater than the square root of 2.

In some embodiments, a spring constant of the lower spring in each spring assembly is equal to a spring constant of the upper spring in each spring assembly.

In some embodiments, the computer system includes a molded plastic mount wherein the molded plastic mount includes the lower spring mount in each spring assembly.

In some embodiments, the one or more fans mounted on the fan deck are attached to a stress-relieved power cable.

Some embodiments include as fourth spring assembly.

In some embodiments, all fans in the computer system are mounted on the fan deck.

In some embodiments, the transmission of the vibrations generated by the one or more fans to the computer system is modified by adjusting a mass of the fan deck.

### BRIEF DESCRIPTION OF THE FIGURES

FIG. 1A depicts a side-view of a system that isolates a computer system from vibrations generated by one or more fans inside the computer system in accordance with some embodiments of the present invention.

FIG. 1B depicts a top-view of the system depicted in FIG. 1A that isolates a computer system from vibrations generated by one or more fans inside the computer system in accordance with some embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

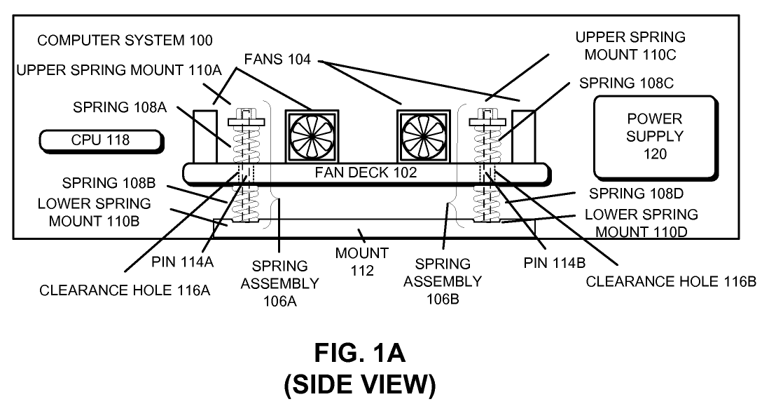

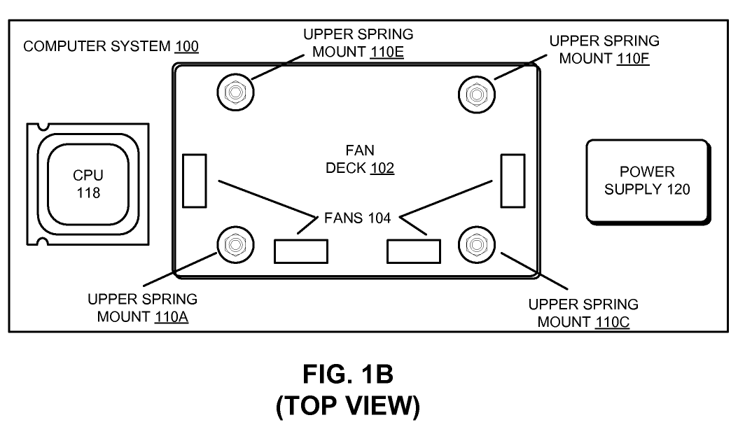

FIG. 1A depicts a side-view of a system that isolates a computer system from vibrations generated by one or more fans inside the computer system in accordance with some embodiments of the present invention. Computer system 100 includes fan deck 102 with four fans 104 mounted on top. Furthermore, the system includes four spring assemblies, two of which, spring assembly 106A and spring assembly 106B, are visible. The other two spring assemblies are hidden in this view, one behind spring assembly 106A and one behind spring assembly 106B.

Spring assembly 106A includes spring 108A preloaded between fan deck 102 and upper spring mount 110A, and spring 108B preloaded between fan deck 102 and lower spring mount 10B in mount 112. Furthermore, pin 114A is coupled to mount 112 and extends through clearance hole 116A in fan deck 102 and is coupled to upper spring mount 108A. Additionally, spring assembly 106B includes spring 108C preloaded between fan deck 102 and upper spring mount 110C, and spring 108D preloaded between fan deck 102 and lower spring mount 110D. Furthermore, pin 114B is coupled to mount 112 and extends through clearance hole 116B in fan deck 102 and is coupled to upper spring mount 110C. Note that each of the four spring assemblies includes two springs.

In the embodiment of FIGS. 1A and 1B, CPU 118 and power supply 120 are shown for exemplary purposes and represent computer system devices that may be cooled by one or more fans mounted on fan deck 102. In other embodiments, fans 104 and/or other fans mounted on fan deck 102 can be used for any purpose in computer system 100, including but not limited to providing air flow in computer system 100 or cooling any system or device.

FIG. 1B depicts a top-view of the system depicted in FIG. 1A. In FIG. 1B, upper spring mount 110A of spring assembly 106A and upper spring mount 110C of spring assembly 106B are visible. Additionally, upper spring mount 110E is visible and is part of the spring assembly hidden behind spring assembly 106A in FIG. 1A. Also, upper spring mount 110F is visible and is part of the spring assembly hidden behind spring assembly 106B in FIG. 1A. Note that fans 104 are controlled and powered through stress-relieved cables that are not shown in FIGS. 1A and 1B. The stress-relieved cables prevent vibrations generated by fans 104 from being transmitted to computer system 100.

In some embodiments, the preload on the springs in a spring assembly can be adjusted by adjusting the top spring mount. For example, the preload on spring 108A and spring 108B can be adjusted by moving upper spring mount 110A with respect to pin 114A. In some embodiments, one or more of upper spring mount 110A, upper spring mount 110C upper spring mount 110E, and upper spring mount 110F include a plate and a nut.

For example, if upper spring mount 110A includes a plate and a nut and pin 114A is threaded, then the preload on spring 108A and spring 108B can be adjusted by threading the nut in spring mount 110A up or down on pin 114A. In other embodiments, spring mount 110A is adjusted on pin 114A and fixed in position using other methods, including but not limited to epoxy, solder, press-fit, interference-fit, or a ratchet and pawl mechanism.

Note that the four clearance holes in fan deck 102, clearance hole 116A, clearance hole 116B and the clearance holes for the 2 spring assemblies not shown in FIG. 1A, have large enough diameters so that as fan deck 102 vibrates laterally, pin 114A, pin 114B, and the pins for the two spring assemblies not shown will not collide with fan deck 102. Additionally, each of the four clearance holes is small enough to provide support for the springs of the spring assembly. For example, clearance hole 116A and clearance hole 116B are small enough to provide support, respectively for spring 108B and spring 108D. Furthermore, fan deck 102 may also include a seat for each spring so that the spring does not shift laterally.

In some embodiments, mount 112 is the case for computer system 100 or is separately manufactured and attached to the case or some other portion of computer system 100. Additionally, in some embodiments, the four pins, pin 114A, pin 114B and the two pins for the two hidden spring assemblies, are molded or manufactured as part of mount 112. For example, in some embodiments, mount 112 is a plastic molded part that is molded as one piece which includes four pins (pin 114A, pin 114B, and the two hidden pins). Furthermore, lower spring mount 110B and lower spring mount 110D may be molded into mount 112. In some embodiments, a lower spring mount includes a seat for a spring so that the spring is constrained from moving laterally on mount 112 or interfering with the pin inside the spring. For example, referring to FIG. 1A, lower spring mount 110B may be formed, molded, or built into mount 112 with a lip or a ring that prevents spring 108B from moving laterally along mount 112.

Note that as depicted in the embodiment of FIG. 1A, the springs are helical coil springs with a cylindrical shape. In some embodiments, other types of springs can be used including but not limited to conically shaped helical coil springs, or coil springs with any desired shape, and can be composed of wire of any cross-section desired. For example, the wire in the spring can be round, oval, rectangular, square or any other desired shape. Furthermore, the springs can be made of metal or plastic.

Additionally, spring constants of the eight springs in the four spring assemblies and the mass of fan deck 102 and fans 104 can be selected so that the resonant frequency of fan deck 102 is a predetermined value. In some embodiments, the resonant frequency of fan deck 102 is selected based on the vibration frequencies generated by one or more of fans 104 during operation of computer system 100. For example, a fundamental vibration frequency generated by one or more of fans 104 may be measured during the operation of computer system 100. Then, spring constants of the eight springs and the mass of fan deck 102 may be selected so that the ratio of the measured fundamental vibration frequency to the resonant frequency of fan deck 102 is a predetermined ratio. In some embodiments, the ratio can include but is not limited to 1, the square root of 2, 2 or a value based on the measured transmission of vibrations from fans 104 to computer system 100 during the operation of computer system 100. For example, if it is desired to reduce the vibrations that are transmitted to computer system 100 from fans 104 in one or more predetermined frequency ranges and/or above a predetermined frequency, then the vibrations of computer system 100 can be monitored as the resonant vibration frequency of fan deck 102 is altered by, for example, adjusting the mass of fan deck 102.

Note that although fan deck 102 has a rectangular shape in the embodiment depicted in FIG. 1B, in other embodiments, fan deck 102 can have any shape desired, and may be a non-planar and/or a non regular shape. For example, the shape of fan deck 102 may be determined based on the desired locations for fans 104 in computer system 100. Additionally, note that although in the embodiments depicted in FIGS. 1A and 1B fan deck 102 includes four fans 104, more or fewer fans may be mounted on fan deck 102. Additionally, in some embodiments, all fans in computer system 100 are mounted on fan deck 102.

Furthermore, although in the embodiments depicted in FIGS. 1A and 1B there are four spring assemblies, more spring assemblies may be used or three spring assemblies may be used. Additionally, in some embodiments, the spring assemblies are arranged so that they are not all collinear. For example, in embodiments in which three spring assemblies are used, the three spring assemblies may be arranged so that when the fan deck is viewed from above, as in FIG. 1B, the spring assemblies form a triangle and are not collinear. Furthermore, in some embodiments, spring assembles are placed to limit out of plane torsion or flexing modes of fan deck 102.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

What is claimed is:

1. An apparatus that isolates a computer system from vibrations generated by one or more fans inside the computer system, the apparatus comprising:
a fan deck upon which the one or more fans are mounted inside the computer system;
three spring assemblies, wherein each spring assembly includes:
a pin, wherein the pin extends through a clearance hole in the fan deck, and wherein a first end of the pin is rigidly coupled to the computer system;
a lower spring, wherein the lower spring extends between a first side of the fan deck and a lower spring mount coupled to the pin; and
an upper spring, wherein the upper spring extends between a second side of the fan deck and an upper spring mount coupled to the pin.

2. The apparatus of claim 1, wherein:
the lower spring mount in each spring assembly is located between the computer system and the first side of the fan deck; and
the upper spring mount in each spring assembly is located between the second end of the pin and the second side of the fan deck.

3. The apparatus of claim 1, wherein:
the lower spring in each spring assembly is preloaded between the first side of the fan deck and the lower spring mount; and
the upper spring is preloaded between the second side of the fan deck and the upper spring mount.

4. The apparatus of claim 1, wherein at least one of the lower spring in each spring assembly and the upper spring in each spring assembly includes a cylindrical helical coil spring.

5. The apparatus of claim 1, wherein at least one of the lower spring in each spring assembly and the upper spring in each spring assembly includes a metal spring.

6. The apparatus of claim 1, wherein a spring constant of the lower spring in each spring assembly, a spring constant of the upper spring in each spring assembly, and a mass of the fan deck and the one or more fans are selected so that a ratio of a fundamental vibration frequency generated by the one or more of the fans during operation of the computer system to a resonant vibration frequency of the fan deck is greater than the square root of 2.

7. The apparatus of claim 1, wherein a spring constant of the lower spring in each spring assembly is equal to a spring constant of the upper spring in each spring assembly.

8. The apparatus of claim 1, wherein the computer system includes a molded plastic mount wherein the molded plastic mount includes the lower spring mount in each spring assembly.

9. The apparatus of claim 1, wherein the one or more fans mounted on the fan deck are attached to a stress-relieved power cable.

10. The apparatus of claim 1, further comprising:
a fourth spring assembly.

11. The apparatus of claim 1, wherein all fans in the computer system are mounted on the fan deck.

12. An apparatus that isolates a computer system from vibrations generated by two or more fans inside the computer system, the apparatus comprising:
a fan deck upon which the two or more fans are mounted inside the computer system, wherein all fans in the computer system are mounted on the fan deck;
three spring assemblies, wherein each spring assembly includes:
a pin, wherein the pin extends through a clearance hole in the fan deck, and wherein a first end of the pin is rigidly coupled to the computer system;
a lower spring, wherein the lower spring is preloaded between a first side of the fan deck and a lower spring mount coupled to the pin, and wherein the lower spring is a metal helical coil spring; and
an upper spring, wherein the upper spring is preloaded between a second side of the fan deck and an upper spring mount coupled to the pin, and wherein the upper spring is a metal helical coil spring.

13. The apparatus of claim 12, wherein the lower spring in each spring assembly is a cylindrical helical coil spring and the upper spring in each spring assembly is a cylindrical helical coil spring.

14. The apparatus of claim 12, further comprising:
a fourth spring assembly.

15. The apparatus of claim 12, wherein a spring constant of the lower spring in each spring assembly, a spring constant of the upper spring in each spring assembly, and a mass of the fan deck and the two or more fans are selected so that a ratio of a fundamental vibration frequency generated by the two or more of the fans during operation of the computer system to a resonant vibration frequency of the fan deck is greater than the square root of 2.

16. A method for isolating a computer system from vibrations generated by two or more fans inside the computer system, the method comprising:
mounting the two or more fans on a fan deck inside the computer system;
generating three pairs of restoring forces, wherein each pair of restoring forces includes:
a first restoring force on a first side of the fan deck;
a second restoring force on a second side of the fan deck; and
wherein a ratio of a fundamental vibration frequency generated by the two or more fans during operation of the computer system to a resonant vibration frequency of the fan deck is greater than the square root of 2.

17. The method of claim 16, wherein the one or more fans includes all fans in the computer system.

18. The method of claim 16, wherein the first restoring force in each pair of restoring forces is a linear restoring force and the second restoring force in each pair of restoring forces is a linear restoring force.

19. The method of claim 16, further including:
generating a fourth pair of restoring forces.

20. The method of claim 16, further including:
modifying the transmission of the vibrations generated by the two or more fans to the computer system by adjusting a mass of the fan deck.
